(19) United States
(12) Patent Application Publication
(10) Pub. No.: US 2025/0158785 A1
(43) Pub. Date: May 15, 2025

(54) MANAGEMENT OF TRANSMISSION CONFIGURATION INDICATOR STATES

(71) Applicant: Nokia Technologies Oy, Espoo (FI)

(72) Inventors: Samantha CAPORAL DEL BARRIO, Aalborg Øst (DK); Sami-Jukka HAKOLA, Kempele (FI); Matha DEGHEL, Paris (FR); Timo KOSKELA, Oulu (FI); Keeth Saliya Jayasinghe LADDU, Espoo (FI); Juha Pekka KARJALAINEN, Oulu (FI); Mihai ENESCU, Espoo (FI)

(21) Appl. No.: 18/838,260

(22) PCT Filed: Feb. 17, 2022
(86) PCT No.: PCT/EP2022/054009

§ 371 Date: Aug. 14, 2024

(51) Int. Cl. H04L 5/00; H04B 17/318; H04W 72/21

(52) U.S. Cl. CPC H04L 5/0055; H04B 17/328; H04W 72/21

(57) ABSTRACT

Examples of the disclosure relate to management of Transmission Configuration Indicator (TCI) States. In examples of the disclosure a User Equipment (UE) can be arranged to receive an indication of a plurality of candidate TCI states. The plurality of candidate TCI states comprise at least one TCI state different to the TCI state with which the UE is currently configured. The UE can also be arranged to transmit an indication of a selected TCI state from the plurality of candidate TCI states where the selected TCI state is different to the TCI state with which the UE is currently configured. The indication of the selected TCI state can be transmitted to a gNB or access node. The transmission of the selected TCI state uses one of a hybrid automatic repeat request (HARQ) acknowledgement (ACK) and an ACK transmission.

### TECHNOLOGICAL FIELD

Examples of the disclosure relate to management of Transmission Configuration Indicator (TCI) States. Some relate to management of TCI states which enable a User Equipment (UE) to select a TCI state for use.

### BACKGROUND

Management of TCI states can be used to reduce losses between a UE and access nodes such as a Base Station (gNB). Management of TCI states can comprise selection of an appropriate TCI state for use with a gNB and UE.

### BRIEF SUMMARY

According to various, but not necessarily all, examples of the disclosure there is provided a User Equipment (UE) comprising:
at least one processor; and
at least one memory including computer program code
the at least one memory and the computer program code configured to, with the at least one processor, cause the UE at least to perform:
receiving an indication of a plurality of candidate Transmission Configuration Indicator (TCI) states wherein the plurality of candidate TCI states comprise at least one TCI state different to the TCI state with which the UE is currently configured; and
transmitting an indication of a selected TCI state from the plurality of candidate TCI states where the selected TCI state is different to the TCI state with which the UE is currently configured; and
wherein the transmission of the selected TCI state uses one of a hybrid automatic repeat request (HARQ) acknowledgement (ACK) and an ACK transmission.

The at least one processor and the at least one memory may be configured to cause the UE to perform switching the UE to the selected TCI state.

The at least one processor and the at least one memory may be configured to cause the UE to assume Uplink transmissions using the selected TCI state starting at a predetermined time following the indication of the selected TCI state.

The HARQ-ACK may be transmitted using the current TCI state.

The ACK may be transmitted using the selected TCI state.

The at least one processor and the at least one memory may be configured to cause the UE to perform selecting a TCI state from the candidate TCI states based on estimated Uplink budgets on the candidate TCI states.

The at least one processor and the at least one memory may be configured to cause the UE to perform selecting a TCI state from the candidate TCI states based on whether a corresponding Reference Signal Received Power (RSRP) is above a threshold level.

The selected TCI state may use a different panel of the UE compared to the current TCI state.

A plurality of TCI states may be associated into a group such that an indication of one of the TCI states in the group as a candidate TCI state enables the UE to consider other TCI states in the group as candidate states.

A reported number of HARQ-ACK bits may be equal to a number of candidate TCI states.

The indication of a plurality of candidate TCI states may be received from one or more node apparatus.

According to various, but not necessarily all, examples of the disclosure there is provided a User Equipment (UE) comprising means for:
receiving an indication of a plurality of candidate Transmission Configuration Indicator (TCI) states wherein the plurality of candidate TCI states comprise at least one TCI state different to the TCI state with which the UE is currently configured; and
   transmitting an indication of a selected TCI state from the plurality of candidate TCI states where the selected TCI state is different to the TCI state with which the UE is currently configured; and
   wherein the transmission of the selected TCI state uses one of a hybrid automatic repeat request (HARQ) acknowledgement (ACK) and an ACK transmission.

According to various, but not necessarily all, examples of the disclosure there is provided a method comprising:
receiving an indication of a plurality of candidate Transmission Configuration Indicator (TCI) states wherein the plurality of candidate TCI states comprise at least one TCI state different to the TCI state with which the UE is currently configured; and
transmitting an indication of a selected TCI state from the plurality of candidate TCI states where the selected TCI state is different to the TCI state with which the UE is currently configured; and
wherein the transmission of the selected TCI state uses one of a hybrid automatic repeat request (HARQ) acknowledgement (ACK) and an ACK transmission.

According to various, but not necessarily all, examples of the disclosure there is provided a computer program comprising computer program instructions that, when executed by processing circuitry, cause:
receiving an indication of a plurality of candidate Transmission Configuration Indicator (TCI) states wherein the plurality of candidate TCI states comprise at least one TCI state different to the TCI state with which the UE is currently configured; and
transmitting an indication of a selected TCI state from the plurality of candidate TCI states where the selected TCI state is different to the TCI state with which the UE is currently configured; and
wherein the transmission of the selected TCI state uses one of a hybrid automatic repeat request (HARQ) acknowledgement (ACK) and an ACK transmission.

According to various, but not necessarily all, examples of the disclosure there is provided a node apparatus comprising:
at least one processor; and
at least one memory including computer program code,
the at least one memory and the computer program code configured to, with the at least one processor, cause the node apparatus at least to perform:
configuring a User Equipment (UE) with a first Transmission Configuration Indicator (TCI) state;
transmitting an indication of a plurality of candidate TCI states to the UE; and
receiving from the UE an indication of a selected TCI state from the plurality of candidate TCI states where the selected TCI state is different to the first TCI state;
wherein the indication of the selected TCI state is received using one of a hybrid automatic repeat request (HARQ) acknowledgement (ACK) and an ACK transmission.

The at least one processor and the at least one memory may be configured to cause the node apparatus to perform configuring the UE with the selected TCI state.

The HARQ-ACK may be received using the first TCI state.

The ACK may be received using the selected TCI state.

A plurality of TCI states may be associated into a group such that an indication of one of the TCI states in the group as a candidate TCI state enables the UE to consider other TCI states in the group as candidate states.

According to various, but not necessarily all, examples of the disclosure there is provided a node apparatus comprising means for:
configuring a User Equipment (UE) with a first Transmission Configuration Indicator (TCI) state;
transmitting an indication of a plurality of candidate TCI states to the UE; and
receiving from the UE an indication of a selected TCI state from the plurality of candidate TCI states where the selected TCI state is different to the first TCI state;
wherein the indication of the selected TCI state is received using one of a hybrid automatic repeat request (HARQ) acknowledgement (ACK) and an ACK transmission.

According to various, but not necessarily all, examples of the disclosure there is provided a method comprising:
configuring a User Equipment (UE) with a first Transmission Configuration Indicator (TCI) state;
transmitting an indication of a plurality of candidate TCI states to the UE; and
receiving from the UE an indication of a selected TCI state from the plurality of candidate TCI states where the selected TCI state is different to the first TCI state;
wherein the indication of the selected TCI state is received using one of hybrid automatic repeat request (HARQ) acknowledgement (ACK) and an ACK transmission.

According to various, but not necessarily all, examples of the disclosure there is provided a computer program comprising computer program instructions that, when executed by processing circuitry, cause:
configuring a User Equipment (UE) with a first Transmission Configuration Indicator (TCI) state;
transmitting an indication of a plurality of candidate TCI states to the UE; and receiving from the UE an indication of a selected TCI state from the plurality of candidate TCI states where the selected TCI state is different to the first TCI state;
wherein the indication of the selected TCI state is received using one of hybrid automatic repeat request (HARQ) acknowledgement (ACK) and an ACK transmission.

### BRIEF DESCRIPTION

Some examples will now be described with reference to the accompanying drawings in which:

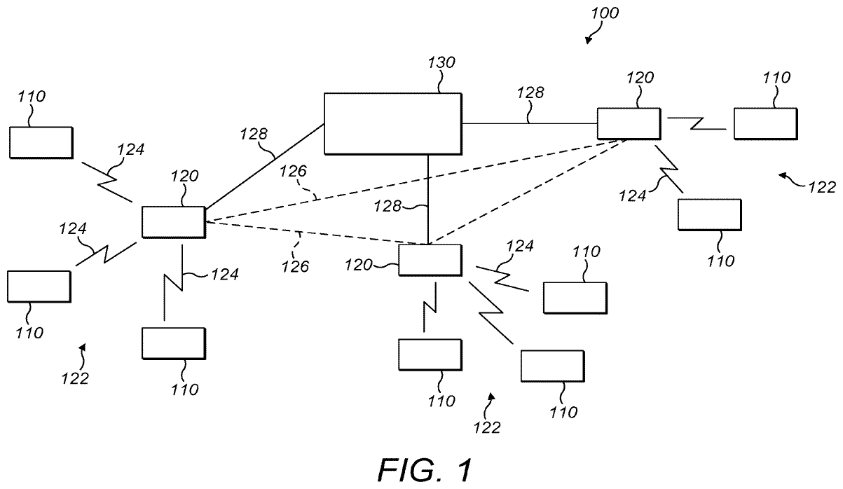

FIG. 1 shows an example network;

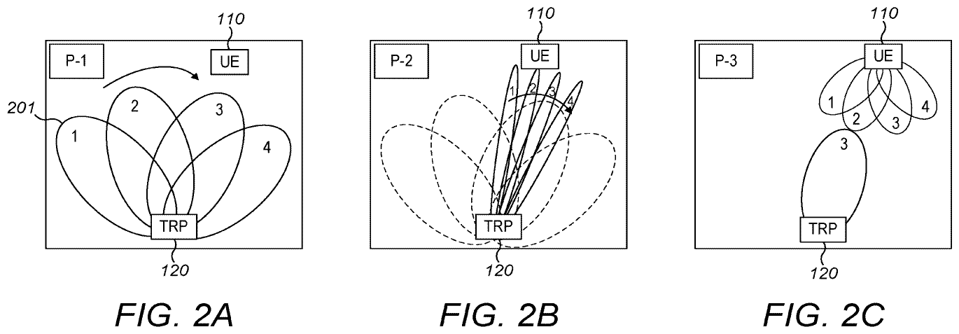

FIGS. 2A to 2C show an example DL beam selection procedure;

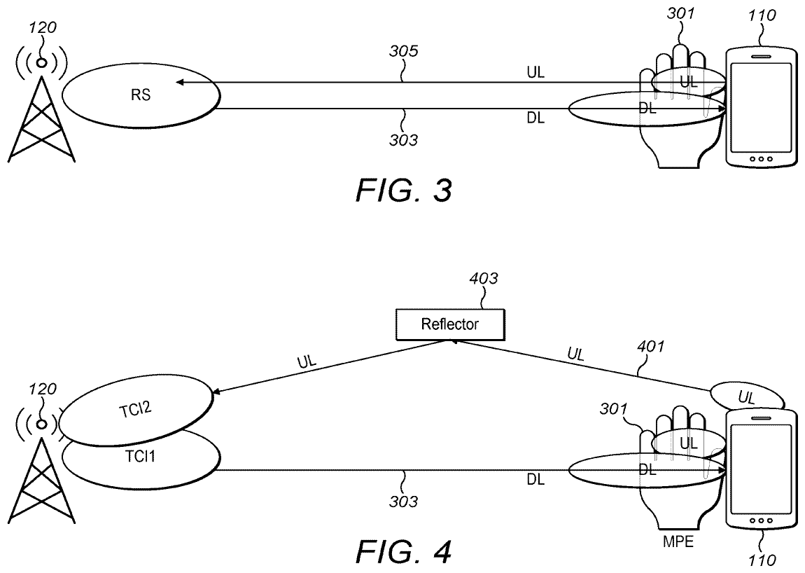

FIG. 3 shows an example scenario of Maximum Permissible Exposure;

FIG. 4 shows alternative TCI states;

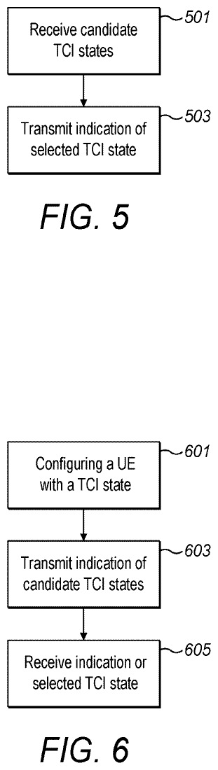

FIG. 5 shows an example method;

FIG. 6 shows an example method;

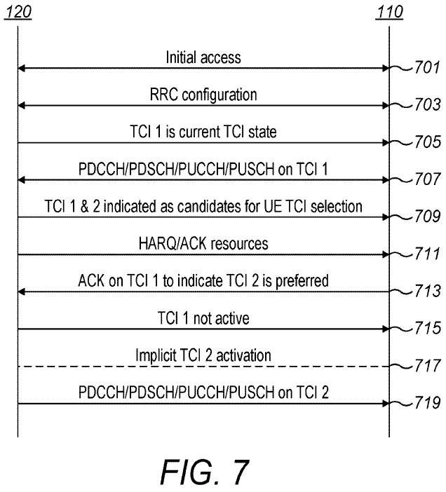

FIG. 7 shows an example signal signaling chart;

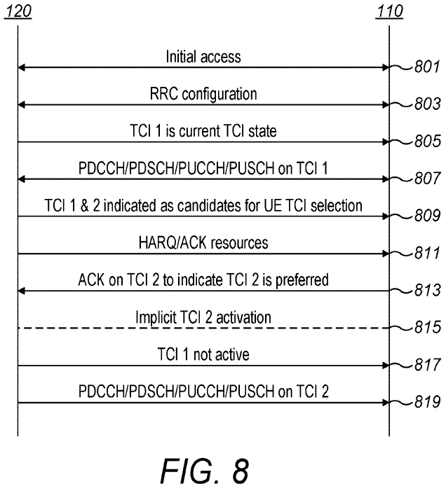

FIG. 8 shows an example signaling chart;

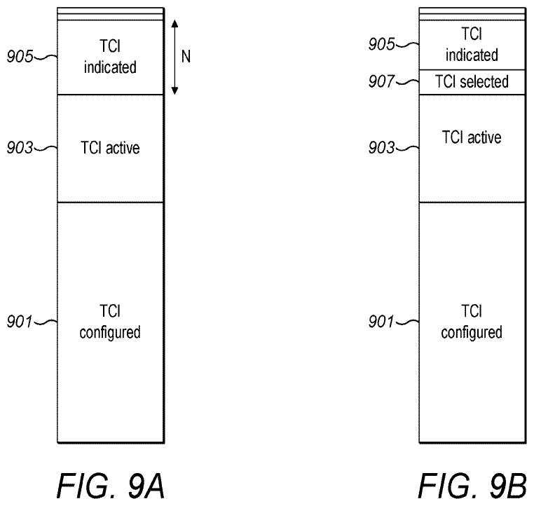

FIGS. 9A and 9B show example TCI states;

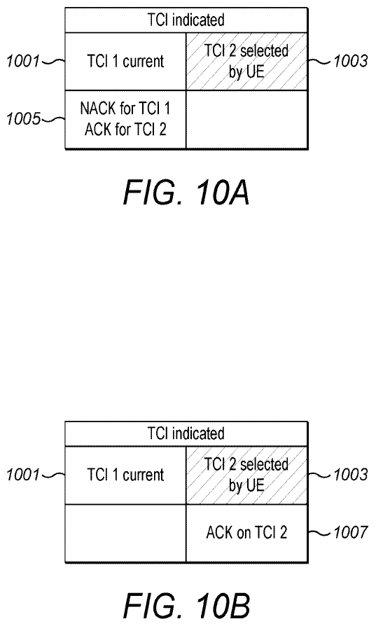

FIGS. 10A and 10B show example HARQ/ACK bits;

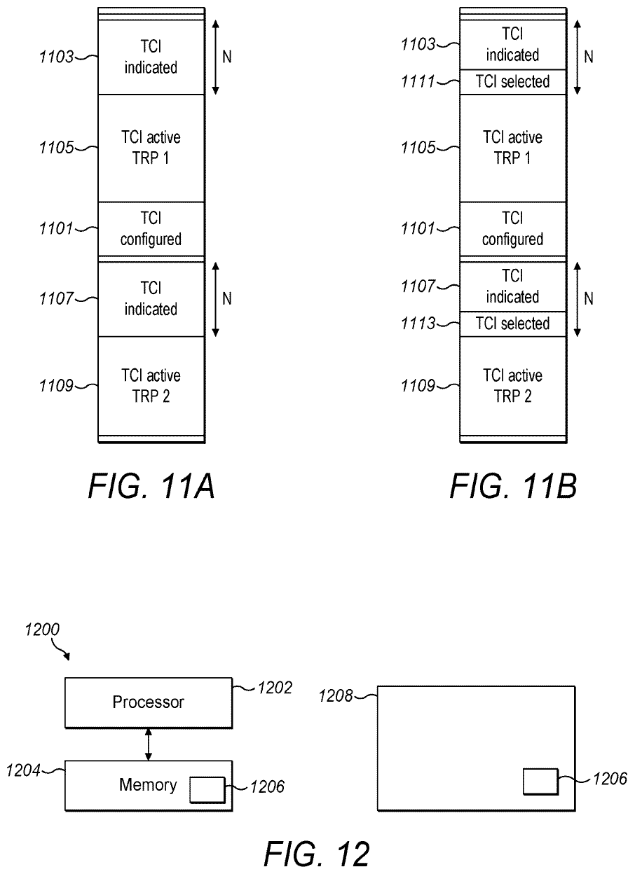

FIGS. 11A and 11B show example TCI states; and

FIG. 12 shows an example controller.

### DEFINITIONS

ACK Acknowledgement
BFR Beam Failure Recovery
CQI Channel Quality Indicator
CSI Channel State Information
CSI RS CSI Reference Signal
DCI Downlink Control Information
DL Downlink
gNB NR Base Station
HARQ Hybrid Automatic Repeat Request
L1 Layer 1
MAC-CE Medium Access Control-Control Element
MCS Modulation and Coding Scheme
MPE Maximum Permissible Exposure
MPR Maximum Power Reduction
PBCH Physical Broadcast Channel
PDCCH Physical Downlink Control Channel
PDSCH Physical Downlink Shared Channel
P-MPR Power Management-Maximum Power Reduction
PRACH Physical Random Access Channel
PUCCH Physical Uplink Control Channel
PUSCH Physical Uplink Shared Channel
QCL Quasi Co-Location
RRC Radio Resource Control
RS Reference Signal
RSRP Reference Signal Received Power
RX Receiving
SINR Signal to Interference plus Noise Ratio
SS Synchronisation Signals
SSB Synchronisation Signal Block
TCI Transmission Configuration Indicator
TRP Transmission Reception Point
TX Transmitting
UE User Equipment
UL Uplink

### DETAILED DESCRIPTION

FIG. 1 illustrates an example of a network 100 comprising a plurality of network nodes including terminal nodes 110, access nodes 120 and one or more core nodes 130. The terminal nodes 110 and access nodes 120 communicate with each other. The one or more core nodes 130 communicate with the access nodes 120.

The one or more core nodes 130 can, in some examples, communicate with each other. The one or more access nodes 120 can, in some examples, communicate with each other.

The network 100 can be a cellular network comprising a plurality of cells 122 each served by an access node 120. In this example, the interface between the terminal nodes 110 and an access node 120 defining a cell 122 is a wireless interface 124.

The access node 120 comprises a cellular radio transceiver. The terminal nodes 110 comprise a cellular radio transceiver.

In the example illustrated the cellular network 100 is a third generation Partnership Project (3GPP) network in which the terminal nodes 110 are user equipment (UE) and the access nodes 120 are base stations.

In the particular example illustrated the network 100 is a Universal Terrestrial Radio Access network (UTRAN). The UTRAN consists of UTRAN NodeBs 120, providing the UTRA user plane and control plane (RRC) protocol terminations towards the UE 110. The NodeBs 120 are interconnected with each other and are also connected by means of the interface 128 to the Mobility Management Entity (MME) 130.

The term ‘user equipment’ is used to designate mobile equipment comprising a smart card for authentication/encryption etc such as a subscriber identity module (SIM). In other examples the term ‘user equipment’ is used to designate mobile equipment comprising circuitry embedded as part of the user equipment for authentication/encryption such as software SIM.

The NodeB can be any suitable base station. A base station is an access node 120. It can be a network element in radio access network responsible for radio transmission and reception in one or more cells to or from the user equipment.

The UTRAN can be a 4G or 5G network, for example. It can for example be a New Radio (NR) network that uses gNB or eNB as access nodes 120. New radio is the 3GPP name for 5G technology.

Such networks 100 can also comprise next generation mobile and communication network, for example, a 6G network.

The access nodes 120 can have different transmission configurations. These different transmission configurations can be defined by beams or spatial filters that are used by the access nodes 120 and the UEs 110. In some examples the different transmission configurations can enable the UEs 110 to receive signals using different panels of the UE 110

A Transmission Configuration Indicator-State (TCI-State) can indicate a transmission configuration between an access node 120 and a UE 110. The TCI-State can be defined by the access node 120 when the UE 110 is in Radio Resource Control (RRC) connected mode. A TCI state can comprise the identity of the relevant cell and Bandwidth part. The TCI State can also specify the relevant Synchronisation Signals (SS)/Physical Broadcast Channel (PBCH) Block or Channel State Information (CSI) Reference Signal, and the relevant Quasi Co-Location (QCL) Type.

QCL types can be type A, type B, type C, or type D. The different types can have different parameters as follows:
QCL-TypeA: {Doppler shift, Doppler spread, average delay, delay spread}
QCL-TypeB: {Doppler shift, Doppler spread}
QCL-TypeC: {Doppler shift, average delay}
QCL-TypeD: {Spatial Rx parameter}

The network 100 can be configured so that a pool comprising of up to 64 TCI-states can be configured for Physical Downlink Control Channel (PDCCH). The network 100 can be configured so that eight of these can be active (Physical Downlink Shared Channel (PDSCH) Medium Access Control-Control Element (MAC-CE)) at the same time.

Beam management functionalities enable a UE 110 to configure its receiving (RX) beams for downlink reception and its transmitting (TX) beams for uplink transmissions. The functionalities can be categorized into four groups:
1. Beam Indication
   Beam indication enables a UE 110 to set its RX and TX beams correctly. The RX beam can be set for the reception of downlink (DL) and the TX beams can be set for the transmission of Uplink (UL), respectively
2. Beam Acquisition, Measurements and Reporting
   This group comprises procedure for providing a gNB 120 with knowledge about feasible DL and/or UL beams for the UE 110.
3. Beam Recovery
   This group comprises procedures for rapid link reconfiguration against sudden blockages. The procedures can enable fast re-alignment of gNB 120 and UE 110 beams
4. Beam Tracking and Refinement
   This group comprises procedures to refine gNB 120 and UE 110 side beams

FIGS. 2A to 2C show an example DL beam selection procedure. This procedure could be part of Beam Acquisition, Measurements and Reporting. The procedure shown in FIGS. 2A to 2C comprises three phases.

The first phase P1 is shown in FIG. 2A. The P1 phase comprises finding the best Synchronisation Signal Block (SSB) beam transmitted by a Transmission Reception Point (TRP) of a gNB 120. This phase can comprise finding the best wide beam of the TRP.

The P1 phase can comprise enabling measurement by the UE 110 of a plurality of different TX beams 201 transmitted by the TRP. This can enable selection of TX beams for the TRP and corresponding RX beams for the UE 110.

The beamforming by the TRP can be implemented using an intra/inter-TRP TX beam sweep from a set comprising a plurality of different beams. The beamforming by the UE 110 can be implemented using a UE 110 RX beam sweep from a set comprising a plurality of different beams.

The second phase P2 is shown in FIG. 2B. The P2 phase comprises finding the best CSI beam transmitted by a TRP of a gNB 120. This phase can comprise finding the best narrow beam of the TRP.

The P2 phase can comprises enabling measurement by the UE 110 of a plurality of different TRP TX beams. This can enable a change of inter/intra-TRP TX beam(s). The measurements of the different TRP TX beams can be from a smaller set of beams than that used in P1 phase. P2 phase can be a special case of P1 phase.

The third phase P3 is shown in FIG. 2C. The P3 phase comprises finding the best narrow beam used by the UE 110 for reception.

The P3 phase can be used to enable measurement by the UE 110 on the same TRP TX beam. This can enable the UE 110 to change the RX beam that is used if the UE 110 is configured to use beamforming.

Examples of this disclosure relate to providing improved UL transmissions for UEs 110. UL failure could occur for UEs 110 experiencing maximum permissible exposure (MPE). FIG. 3 shows an example scenario of a UE 110 experiencing MPE.

FIG. 3 shows a UE 110 receiving a DL signal 303 from a gNB 120 and transmitting UL signals 305 to the gNB 120. In the example shown in FIG. 3 the UE 110 is a mobile phone. Other types of UE 110 could be used in other examples of the disclosure.

In this scenario a part of a human body is blocking the UE 110. The part of the human body in this example is a hand 301 belonging to the user of the UE 110. In this scenario the UE 110 has restricted power for transmission so that the MPE for the user of the UE 110 is not exceeded.

Although FIG. 3 shows UL failure due to MPE examples of the disclosure could be used for scenarios with any cause for UL failure. For example, there could be high UL interference, coverage limitations, internal conditions of the UE 110 which lead to high maximum power reduction (MPR) or any other suitable scenarios. Internal conditions of the UE 110 which lead to high MPR could comprise overheating or any other applicable condition.

In these scenarios it is possible for the uplink beam to fail while the downlink beam still works.

When UL failure occurs the UE 110 has to perform connection reestablishment with Physical Random Access Channel (PRACH) followed by a beam selection procedure such as that shown in FIGS. 2A to 2C. This means that UL failure can have significant consequences for latency and signalling.

When UL failure occurs, the UE 110 needs to switch to a different beam or TCI state. The UE 110 needs to inform the network and/or the gNB 120 that it will be doing this. Examples of the disclosure therefore provide apparatus and methods for enabling a UE 110 to inform a network or gNB that it is switching beams or TCI states. Examples of the disclosure can provide the UE 110 with more choice in UL beam selection in order to reduce the chances of UL beam failure.

FIG. 4 schematically shows alternative TCI states that can be used by a UE 110 if there is a UL failure. FIG. 4 shows an MPE scenario in which a user's hand is blocking the UE 110. Other scenarios for causing the UL failure could occur in other cases.

In the example of FIG. 4 a first beam is used for the DL signal between the gNB 120 and the UE 110. This DL signal is transmitted directly to the UE 110 without any reflections. The UE 110 can receive this DL signal using a first TCI state or beam.

In the scenario shown in FIG. 4 the user's hand 301 blocking the UE 110 would cause the UL signal to fail if it used the same beam as the DL signal 303. To avoid this problem the UE 110 can select to transmit UL signals 401 using a different TCI state or beam. In this example the TCI state or beam that was originally used for the UL signals 305 as shown in FIG. 3 is replaced with the different TCI state or beam for the UL signals 401 as shown in FIG. 4.

In this case the UL signals 401 can be transmitted using a different panel of the UE 110. In the example of FIG. 4 a side panel of the UE 110 is used to receive the DL signal 305 but a top panel can be used to transmit the UL signal 401. This helps the UL signal 401 to avoid the user's hand 301 or any other blockage.

The UL signal 401 that is transmitted from the top panel is reflected from a reflector 403 towards the gNB 120.

FIG. 5 shows an example method that can be performed by a UE 110. The UE 110 could be a smartphone or any other suitable type of UE 110. The UE 110 can be configured to communicate with an access node 120 that performs the method shown in FIG. 6 or other similar method. The UE 110 could be in a network 100 as shown in FIG. 1 or any other suitable type of network 100.

The method comprises, at block 501, receiving an indication of a plurality of candidate TCI states. The different TCI states can use different beams for transmission by the UE 110 and/or reception by the UE 110. In some examples the different TCI states can enable the UE 110 to make use of different panels of the UE 110 for transmission and/or reception.

The plurality of candidate TCI sates comprise at least one TCI state which is different to the TCI state with which the UE 110 is currently configured. That is, the UE 110 can be initially configured with a TCI state by the gNB 120. The plurality of candidate TCI states can comprise at least one different TCI state so as to provide an alternative TCI state or beam that can be used in the event of failure of the current TCI state.

The indication of the plurality of candidate TCI states can be received from a gNB 120 or other suitable network apparatus. In some examples the indication of a plurality of candidate TCI states can be received from a single gNB 120. In some examples the indication of a plurality of candidate TCI states can be received from a plurality of gNBs 120.

The indication of the plurality of candidate TCI states can be received in any suitable format. In some examples a plurality of TCI states can be associated into a group such that an indication of one of the TCI states in the group as a candidate TCI state enables the UE 110 to consider other TCI states in the group as candidate states. In such examples the indication that is received at block 501 could comprise an indication of the associated group of TCI states rather than an indication of each of the TCI states within the group. The UE 110 can be notified of the TCI states that are associated with a respective group by any suitable means. For instance, the UE 110 could receive information indicative of the associations during configuration using RRC signalling or during activation using MAC-CE signalling.

At block 503 the method comprises transmitting an indication of a selected TCI state. The indication of the selected TCI state can be transmitted from the UE 110 to the gNB 120 or any other suitable part of the network 100.

The selected TCI state can be selected from the plurality of candidate TCI states that were received at block 501. The selected TCI state can be different to the TCI state with which the UE 110 is currently configured. This enables the selected TCI state to be used as an alternative TCI state.

The TCI-state can be selected from the plurality of candidate TCI states by the UE 110. Any suitable process can be used to enable the UE 110 to select a TCI state from the plurality of candidate TCI states. In some examples the TCI state can be selected based on estimated Uplink budgets on the candidate TCI states.

In some examples the UE 110 can be configured to measure the RSRP for the respective candidate TCI-states. The TCI state can then be selected based on whether a corresponding Reference Signal Received Power (RSRP) is above a threshold level. In some examples the network 100 can indicate the RSRP threshold that is to be used by the UE 110 when selecting a new TCI state. The RSRP threshold can be affected by MPE events or any other appropriate factors. Other metrics can be used to select a TCI state such as Signal to Interference plus Noise Ratio (SINR) or any other suitable metric.

The measurement of the RSRP that are used to enable selection of a candidate TCI state can be Layer 1 (L1)—RSRP measurements. This can enable the UE 110 to switch quickly between different beams. This can enable the UE 110 to evaluate the RSRP for the different beams of the different candidate TCI states.

The TCI state that is selected can make use of a different panel of the UE 110 compared to the current TCI state. For example, the TCI state with which the UE 110 is initially configured by the gNB 120 could make use of a side panel of the UE 110. The selected TCI state could then make us of a top panel or a different side panel to help to avoid any blockages or other problems of the original TCI state

Any suitable means can be used to indicate the selected TCI state. In some examples the indication could comprise one or more bits within a message or suitable signal. For example, the bits could be transmitted using a hybrid automatic repeat request (HARQ) acknowledgement (ACK). In such examples the HARQ-ACK can be transmitted using the current TCI state. That is, the state with which the gNB 120 has initially configured the UE 110.

The reported number of HARQ-ACK bits can be equal to the number of candidate TCI states that have been indicated such that an nth bit in a HARQ-ACK corresponds to the nth candidate TCI state. The value of each of the HARQ-ACK bits can provide an indication of whether or not the corresponding TCI state has been selected.

In some examples the means for indicating the selected TCI state could comprise the use of the selected TCI state for a transmission. In such examples the transmission of the selected TCI state could use an ACK transmission.

In some examples, to report the selected TCI state the UE 110 can be configured to report an index of the selected one or more TCI states. For instance, in examples where there are two candidate TCI states a single bit can be used to indicate which TCI state has been selected. In such examples, the UE 110 can report ‘0’ to indicate that the first TCI state is selected and ‘1’ to indicated that the second TCI state is selected.

When a TCI state has been selected the UE 110 can be switched to the selected TCI state. The switching of the UE 110 to the selected TCI state can occur after the indication of the selected TCI state has been transmitted. For instance, if a HARQ-ACK is used to indicate the selected TCI states then the switching could occur after the gNB 120 has received the HARQ-ACK and is informed of the selected TCI state. In other examples the switching of the UE 110 to the selected TCI state can occur before the indication of the selected TCI state has been transmitted. For instance, if an ACK transmission is used to indicate the selected TCI state this can be transmitted using the selected TCI state.

In some examples the UE 110 can assume UL transmission using the selected TCI state at a predetermined time following the indication of the selected TCI state. The UL transmissions using the selected TCI state can start at a predetermined time following the indication of the selected TCI state. For instance, the UE 110 could assume UL transmission using the selected TCI state at a given time period following the transmission of the indication of the selected TCI state. The predetermined time could comprise a given number of slots or a given number of symbols.

FIG. 6 shows an example method that can be performed by a node apparatus 120 such as gNB 120 or any other suitable access node. The node apparatus 120 can be configured to communicate with a UE 110 such as the UE 110 that performs the method shown in FIG. 5 or other similar methods. The node apparatus 120 could be in a network 100 as shown in FIG. 1 or any other suitable type of network 100.

The method comprises, at block 601, configuring a UE 110 with a first TCI state. Any suitable process can be used to configure the UE 110 the first TCI state. The TCI state can make use of a first beam. The first TCI state can enable DL and UL communication with the UE 110.

At block 603 the method comprises transmitting an indication of a plurality of candidate TCI states to the UE 110. The indication of the plurality of candidate TCI states can be provided to the UE 110 during the configuration of the UE 110 with the first TCI state or at a different time.

The plurality of candidate TCI sates comprise at least one TCI state which is different to the TCI state with which the UE 110 is configured at block 601. The plurality of candidate TCI states can comprise at least one different TCI state so as to provide an alternative TCI state or beam that can be used in the event of failure of the current TCI state.

Any suitable signalling process can be used to transmit the plurality of candidate TCI states. In some examples the access node 120 can indicate the candidate TCI states in Downlink Control Information (DCI) or in any other suitable information.

The indication of the plurality of candidate TCI states can be transmitted in any suitable format. In some examples a plurality of TCI states can be associated into a group such that an indication of one of the TCI states in the group as a candidate TCI state enables the UE 110 to consider other TCI states in the group as candidate states. In such examples the indication that is transmitted at block 603 could comprise an indication of the associated group of TCI states rather than an indication of each of the TCI states within the group. The access node 120 can notify the UE 110 of the TCI states that are associated with a respective group by any suitable means. For instance, the access node 120 could transmit information indicative of the associations during configuration using RRC signalling or during activation using MAC-CE signalling.

At block 603 the method comprises receiving from the UE 110 an indication of a selected TCI state from the plurality of candidate TCI states. The selected TCI state is different to the first TCI state. This enables the selected TCI state to be used as an alternative TCI state.

The UE 110 can use any suitable process to select a TCI state from the plurality of candidate TCI states. In some examples the TCI state can be selected based on estimated Uplink budgets on the candidate TCI states. The UL budgets can comprise any suitable parameters. In some examples the UE can measure DL RSRP and estimate the UL Power Management-Maximum Power Reduction (P-MPR). This gives a measure of power back-off due to MPE or any other appropriate factors. The P-MPR can be subtracted from the DL RSRP to estimate the UL power budget. The UL budgets can also comprise other parameters such as array directivity/gain to add to the UL budget or other MPR factors such as Modulation and Coding Scheme (MCS) or over heating to subtract from the UL budget.

In some examples the UE 110 can be configured to measure the RSRP for the respective candidate TCI-states. The TCI state can then be selected based on whether a corresponding Reference Signal Received Power (RSRP) is above a threshold level.

Any suitable means can be used to receive the indication of the selected TCI state. In some examples the indication could comprise one or more bits within a message or suitable signal. For example, the bits could be transmitted using a hybrid automatic repeat request (HARQ) acknowledgement (ACK). In such examples the HARQ-ACK can be transmitted using the current TCI state. That is, the state with which the gNB 120 has initially configured the UE 110.

Once the node apparatus 120 has received the indication of the selected TCI state the UE 110 can then be configured with the selected TCI state. For example, the UE 110 can switch the selected TCI state or the UE can wait for confirmation of the selection from the gNB 120. This can then enable UL transmission from the UE 110 to be transmitted using the selected TCI state rather than the original TCI state.

In the example of FIG. 6 the method is performed by a single node apparatus 120. In other examples a plurality of node apparatus 120 can transmit an indication of candidate TCI states so that the UE 110 can receive the notifications from a plurality of different node apparatus 120.

In some examples of the disclosure the UE 110 can be configured to provide an indication of failure of the UL channel. For instance, the UE 110 could provide an indication of the occurrence of an MPE event. Such an indication could provide a trigger for the gNB 120 to provide an indication of the candidate TCI states.

In both the examples shown in FIGS. 5 and 6 the UE 110 indicates a selected TCI state. After the TCI state has been selected the UE 110 can assume transmissions using the selected TCI state. The use of the transmissions using the indicated TCI states can be assumed starting at a predetermined time after the transmission of the indication of the selected TCI state. For instance, the use of the selected TCI state can be assumed starting at a given number of slots or symbols after the transmission of the indication of the selected TCI state. Any UL transmissions that occur before the assumption of the selected TCI state can be transmitted using the original TCI state. In other examples the UE 110 might not automatically assume the use of the selected TCI state.

In other circumstances the UE 110 could determine that none of the candidate TCI states are suitable. For example none of the indicated TCI states might meet the criteria for selection. In such cases the UE 110 could signal NACKs for each of the TCI states to indicate to the gNB 120 than none of the candidate TCI states are suitable. In such cases the UE 110 might not assume UL transmission using a different TCI state. In such examples the UE 110 can send a NACK signal on all of the HARQ resources and continues to transmit on UL using the current TCI state. In such examples the UE 110 could trigger beam scanning to find a suitable TCI state. gNB 120 can update the list of candidate TCI states or the UE 110 could report a new beam index or pool of TCI states to search among. The methods shown in FIGS. 5 and 6 could be performed again following the scanning. The processes could be repeated as many times as needed.

In some examples if the UE 110 does not select any of the candidate TCI states, for example if none of the candidate TCI states meet the selection criteria then the UE 110 could be configured to trigger Beam Failure Recovery (BFR). BFR can be triggered after the transmission of the NACK signals.

In some examples the UE 110 can select more than one candidate TCI state. For example, the UE 110 could signal the best UL beam and also a second best UL beam. In such examples the gNB 120 can indicate N candidate TCI states. The N candidate TCI states can be indicated in the DCI or using any other suitable process. The UE 110 can then be configured to select Q TCI states where Q<N. The UE 110 can then be configured to transmit on one Physical Uplink Shared Channel (PUSCH)/Physical Uplink Control Channel (PUCCH) resource, or on a plurality of PUSCH/PUCCH resources where the PUSCH/PUCCH resources are associated with the selected Q TCI states. In examples where the UE 110 uses the best UL beam for the indication of the acknowledgement message, the HARQ-ACK state can be used to signal the second best UL beam.

In some examples of the disclosure the candidate TCI states that are indicated by the gNB 120 can comprise the TCI state with which the UE 110 is currently configured and also one or more other candidate TCI states. These candidate TCI states can be indicated using the DCI, or any other suitable process. The UE 110 can be provided with information that enables the UE 110 to distinguish between candidate TCI states that can be used for implementing examples of the disclosure and TCI states that are to be used for updates to the current applicable TCI state. To provide this information, designated entries or bits within a DCI or MAC CE field can be used. The entries or bits within a DCI or MAC CE field can be new or existing entries or bits that have been reserved. These designated entries or bits can be used to inform the UE 110 of whether the indicated one or more TCI states are candidate TCI states or not. This provides an indication to the UE 110 as to whether the selection of the TCI state should be performed by the UE 110 or not.

As an addition or alternative to this, in some examples, whether a TCI state is a candidate TCI state may be configured and/or indicated as part of the TCI state itself. This indication and/or configuration can be made using RRC or any other suitable process. In some examples this indication and/or configuration can be made and/or updated for one or more TCI states using MAC CE.

FIG. 7 shows an example signal signaling chart that can be used in examples where the UE 110 has the capability to select a TCI state from a plurality of candidate TCI states and report a selected TCI state. The signaling chart shows a method that can be implemented by a system comprising a UE 110 and an access node 120 such as a gNB. The UE 110 and the access node 120 can be within a network 100 such as the network 100 of FIG. 1 or any other suitable type of network.

At block 701 the UE 110 and the gNB 120 perform an initial access process. The initial access process can enable the UE 110 to establish communication with the gNB 120. The initial access process can comprise an example DL beam selection procedure or any other suitable process.

At block 703 the method comprises the UE 110 and the gNB 120 performing an RRC configuration process.

At block 705 the gNB 120 signals to the UE 110 that TCI state1 is the current TCI state. This enables the UE 110 to be configured in TCI state1. The UE 110 can be configured to use TCI state 1 for both DL and UL communications.

At block 707 TCI state 1 is used for PDCCH, PDSCH, PUCCH, and PUSCH between the UE 110 and the gNB 120.

At block 709 the gNB 120 signals to the UE 110 a plurality of available candidate TCI states. In this example the plurality of available candidate TCI states comprise TCI state 1 and TCI state 2. That is, the plurality of available candidate TCI states comprise both the current TCI state and at least one other TCI state. The gNB 120 could indicate more than two candidate TCI states in other examples of the disclosure. In such examples the gNB 120 could signal N available candidate TCI states.

FIG. 7 shows the example for a single TRP. In other examples a plurality of TRPs could be used an each TRP could have two or more candidate TCI states. In such examples each TRP could signal the plurality of available candidate TCI states to the UE 110.

The indication of the plurality of available candidate TCI states enables the UE 110 to select an alternative TCI state for use. For example, if the UE 110 determines that communication using the current TCI state is likely to fail it can select an alternative TCI state.

The indication of the plurality of available candidate TCI states can be made using any suitable process or resources. In some examples the indication could be made using an existing DCI information framework. In some examples the indication could be made using an extended DCI information framework.

In examples where an existing DCI indication framework is used the UE 110 can receive a configuration (RRC) or an activation (MAC-CE) that associates TCI states in certain groups. Each group can comprise one or more possible candidate TCI states for a unified TCI state. If the UE 110 is indicated with one TCI state that is associated with a group, the UE 110 can consider all other TCI states in the group as candidate TCI states for HARQ-ACK reporting. In such cases the number of reported HARQ-ACK bits can be equal to the number of candidate TCI states in the group.

In examples where an extended DCI indication framework is used the UE 110 can receive an extended DCI. The extended DCI can comprise a new TCI field size or a plurality of TCI fields or could be extended in any other suitable way. The extended DCI can indicate a plurality of TCI states as possible candidate TCI states. The possible candidate TCI states can be for a unified TCI state. In such cases the number of reported HARQ-ACK bits can be equal to the number of candidate TCI states indicated in the DCI.

At block 711 the gNB 120 signals HARQ/ACK resources to the UE 110. In this example the resources for HARQ-ACK are configured with codepoints and bits for HARQ-ACK transmission of the selected TCI state by the UE 110. In this example there are two candidate TCI states and so the resources for HARQ-ACK are configured with two codepoints and two bits for HARQ-ACK transmission of the selected TCI state. In examples where there are n candidate TCI states and the resources for HARQ-ACK are configured with n codepoints and n bits or fewer for HARQ-ACK transmission of the selected TCI state. The codepoints that are used can comprise any suitable codepoints.

At block 713 the UE 110 signals to the gNB 120 that TCI state 2 is preferred for UL transmission. This therefore provides an indication of a selected TCI state. In this example the UE 110 sends HARQ-ACK providing an indication of the selected TCI state. The HARQ-ACK feedback can be used to indicate both the selected candidate TCI states and the TCI states that have not been selected. This signal can provide a trigger for the gNB 120 to switch to a different TCI state and reconfigure the UE 110 in a different TCI state. In other examples the UE 110 could switch to using the selected TCI state. In such examples the gNB 120 could assume the selected TCI state for the reception of UL transmissions.

In some examples, a Physical Uplink Control Channel (PUCCH) resource can be used to carry the HARQ-ACK feedback. In some examples different PUCCH resources can be used to carry different parts of the HARQ-ACK bits. For instance, different PUCCH resources can be used to carry the ACK(s) and NACK(s), respectively.

In the example of FIG. 7 the HARQ-ACK feedback is used to report both the TCI states that have been selected and the TCI states that have not been selected. In this example the number of HARQ-ACK bits can be equal to the number of indicated candidate TCI states. These HARQ-ACK bits can be treated as part of the HARQ-ACK codebook, if any. For example, the DCI indicating candidate TCI states can trigger a plurality of HARQ-ACK bits where each of the plurality of HARQ-ACK bits corresponds to a candidate TCI state. The TCI state corresponding to the nth candidate TCI state is represented by the nth HARQ-ACK bit of the plurality of HARQ-ACK bits. For example, these bits can be aggregated one after the other in the HARQ-ACK codebook (if any). The location of the first bit of these bits within the HARQ-ACK codebook can be determined based on legacy procedures. Alternatively, these HARQ-ACK bits can be appended or prepended to the HARQ-ACK codebook, if any.

At block 715 the gNB 120 signals to the UE 110 that TCI state 1 is no longer active and at block 717 the gNB 120 and the UE 110 perform activation of the selected TCI state, TCI state 2. Following the activation of the selected TCI state, at block 719, TCI state 2 is used for PDCCH, PDSCH, PUCCH, and PUSCH between the UE 110 and the gNB 120.

In the example of FIG. 7 the TCI state that has been selected for UL transmission by the UE 110 becomes applicable, or is applied, after a predetermined time. The predetermined time could comprise k slots or k symbols after the indication of the selected TCI states or from the PDCCH indicating the candidate TCI states or from any other reference point. The value of k could be based on the capabilities of the UE 110, the configuration of the gNB 120 and any other suitable factor. The value of k must be greater than or equal to the indicated capability of the UE 110.

In the example of FIG. 7 the UE 110 selects at least one of the candidate TCI states and sends HARQ-ACK providing an indication of the selected TCI state. In other circumstances the UE 110 could determine that none of the candidate TCI states meet the criteria for selection. In such cases the UE 110 could signal NACKs for each of the TCI states to indicate to the gNB 120 than none of the candidate TCI states are suitable.

FIG. 8 shows another example signal signaling chart that can be used in examples where the UE 110 has the capability to select a TCI state from a plurality of candidate TCI states and report a selected TCI state. The signaling chart shows a method that can be implemented by a system comprising a UE 110 and an access node 120 such as a gNB. The UE 110 and the access node 120 can be within a network 100 such as the network 100 of FIG. 1 or any other suitable type of network.

In this example, instead of using the original TCI state to provide an indication of the selected TCI state the UE 110 will provide signaling on the selected TCI state itself to provide the indication of the alternative TCI state that has been selected.

At block 801 the UE 110 and the gNB 120 perform an initial access process and at block 803 the UE 110 and the gNB 120 perform an RRC configuration process. At block 805 the gNB 120 signals to the UE 110 that TCI state 1 is the current TCI state. At block 807 TCI state 1 is used for PDCCH, PDSCH, PUCCH, and PUSCH between the UE 110 and the gNB 120.

At block 809 the gNB 120 signals to the UE 110 a plurality of available candidate TCI states. In this example the plurality of available candidate TCI states comprise TCI state 1 and TCI state 2. The gNB 120 could indicate more than two candidate TCI states in other examples of the disclosure.

Blocks 801 to 809 can be similar to blocks 701 to 709 as shown in FIG. 7

At block 811 the gNB 120 signals HARQ/ACK resources to the UE 110.

At block 813 the UE 110 signals to the gNB 120 that TCI state 2 is preferred for UL transmission. In the example of FIG. 8 this is made by signaling ACK on the selected TCI state 2. That is, the UE 110 can indicate a selected TCI state by using it to provide an ACK signal.

The UE 110 can use PUCCH/PUSCH resources to indicate that TCI state 2 has been selected for the TCI state. To enable the PUCCH/PUSCH resources to be used to indicate that TCI state 2 has been selected for the TCI state the UE 110 can be configured with a plurality of PUCCH/PUSCH resources. In this example there are two candidate TCI states and so the UE 110 can be configured with two PUCCH/PUSCH resources.

In examples where there are n candidate TCI states the UE 110 can be configured with n PUCCH/PUSCH resources. The UE 110 can select which PUCCH (HARQ-ACK) resource to use for transmitting the ACK(s) based on the one or more selected TCI states.

The use of TCI state 2 to provide the ACK signal provides an indication of the selected TCI state. This signal provides a trigger for the gNB 120 to switch to a different TCI state and reconfigure the UE 110 in a different TCI state. In other examples the UE 110 could switch to using the selected TCI state. In such examples the gNB 120 could assume the selected TCI state for the reception of UL transmissions.

At block 815 the gNB 120 and the UE 110 perform activation of the selected TCI state, TCI state 2 and at block 817 the gNB 120 signals to the UE 110 that TCI state 1 is no longer active. Following the activation of the selected TCI state, at block 819, TCI state 2 is used for PDCCH, PDSCH, PUCCH, and PUSCH between the UE 110 and the gNB 120.

FIGS. 9A and 9B schematically show example TCI states for the UE 110. FIG. 9A shows the categories of TCI states for the UE 110 after the gNB 120 has indicated the candidate TCI states. FIG. 9B shows the categories of TCI states for the UE 110 after the UE 110 has selected one of the candidate TCI states.

FIG. 9A shows three different categories of TCI states. The different categories are configured 901, active 903 and indicated 905. The configured TCI states are TCI states that the UE 110 is currently configured to use. The active TCI states are states that could be used by the UE 110. The indicated TCI states 905 are the plurality of candidate states that have been indicated by the gNB 120. In this example the indicated candidate TCI states 905 comprise the configured TCI state 901. In this example N candidate states have been indicated.

FIG. 9B shows an additional category of TCI states. The additional category is the selected TCI state 907. The selected TCI state 907 is one of the N indicated TCI states 905.

FIGS. 10A and 10B show example HARQ/ACK bits that can be used in different implementations of the disclosure. These bits can be used by the UE 110 to indicate the TCI state that has been selected by the UE 110 for the TCI state.

FIG. 10A shows example HARQ/ACK bits that can be used when the UE 110 indicates the selected TCI state using the current TCI state. For example, the bits shown in FIG. 10A could be used in examples such as the example of FIG. 7.

The HARQ/ACK bits comprise a bit 1001 indicating the current TCI state 1 and a bit 1003 indicating the selected TCI state 2. In this example the HARQ/ACK bits comprise a bit 1005 that indicate the NACK for TCI state 1 and ACK for TCI state 2.

FIG. 10B shows example HARQ/ACK bits that can be used when the UE 110 indicates the selected TCI state by using the selected TCI state. For example, the bits shown in FIG. 10A could be used in examples such as the example of FIG. 8.

The HARQ/ACK bits comprise a bit 1001 indicating the current TCI state 1 and a bit 1003 indicating the selected TCI state 2. In this example the HARQ/ACK bits comprise a bit 1007 that indicates the ACK for TCI state 2 on TCI state 2.

FIGS. 11A and 11B schematically show example TCI states for the UE 110 for a multi TRP example. In this example two TRPs are used. In this example there are two sets of up to eight active TCI states. Other numbers of TCI states and TRP points could be used in other examples.

FIG. 11A shows the categories of TCI states for the UE 110 after the gNB 120 has indicated the candidate TCI states. FIG. 11B shows the categories of TCI states for the UE 110 after the UE 110 has selected one of the candidate TCI states.

FIG. 11A shows different categories of TCI states. The different categories are configured 1101, active 1103, 1109 and indicated 1105, 1107. The configured TCI states are TCI states that the UE 110 is currently configured to use.

The active TCI states 1103, 1109 are states that could be used by the UE 110. The active TCI states 1103, 1109 comprise TCI states 1103 for the first TRP and TCI states 1109 for the second TRP.

The indicated TCI states 1105, 1107 are the plurality of candidate states that have been indicated by the gNB 120. In this example the indicated candidate TCI states 1105, 1107 comprise indicated TCI states 1105 for the first TRP and indicated TCI states 1107 for the second TRP. In this example N candidate states have been indicated for each of the first TRP and the second TRP.

FIG. 11B shows the selected TCI states 1111, 1113. In this example a TCI stat is selected for each of the TRPs. The selected TCI states 1111, 1113 are states from the respective groups of N indicated TCI states 1105, 1107.

FIG. 12 illustrates an example of a controller 1200. The controller 1200 could be provided within an apparatus such as a UE 110 or a gNB. Implementation of a controller 1200 can be as controller circuitry. The controller 1200 can be implemented in hardware alone, have certain aspects in software including firmware alone or can be a combination of hardware and software (including firmware).

As illustrated in FIG. 12 the controller 1200 can be implemented using instructions that enable hardware functionality, for example, by using executable instructions of a computer program 1206 in a general-purpose or special-purpose processor 1202 that may be stored on a computer readable storage medium (disk, memory etc.) to be executed by such a processor 1202.

The processor 1202 is configured to read from and write to the memory 1204. The processor 1202 may also comprise an output interface via which data and/or commands are output by the processor 1202 and an input interface via which data and/or commands are input to the processor 1202.

The memory 1204 stores a computer program 1206 comprising computer program instructions (computer program code) that controls the operation of the apparatus when loaded into the processor 1202. The computer program instructions, of the computer program 1206, provide the logic and routines that enables the apparatus to perform the methods illustrated in FIGS. 5 to 6 The processor 1202 by reading the memory 1204 is able to load and execute the computer program 1206.

In examples where the controller 1200 is provided within a UE 110 the controller 1200 therefore comprises: at least one processor; and at least one memory including computer program code; the at least one memory and the computer program code configured to, with the at least one processor, cause the apparatus at least to perform;
receiving an indication of a plurality of candidate Transmission Configuration Indicator (TCI) states wherein the plurality of candidate TCI states comprise at least one TCI state different to the TCI state with which the UE is currently configured; and
transmitting an indication of a selected TCI state from the plurality of candidate TCI states where the selected TCI state is different to the TCI state with which the UE is currently configured; and
wherein the transmission of the selected TCI state uses one of a hybrid automatic repeat request (HARQ) acknowledgement (ACK) and an ACK transmission.

In examples where the controller 1200 is provided within an access node 120 the controller 1200 therefore comprises: at least one processor; and at least one memory including computer program code; the at least one memory and the computer program code configured to, with the at least one processor, cause the apparatus at least to perform;
configuring a User Equipment (UE) with a first Transmission Configuration Indicator (TCI) state;
transmitting an indication of a plurality of candidate TCI states to the UE; and receiving from the UE an indication of a selected TCI state from the plurality of candidate TCI states where the selected TCI state is different to the first TCI state;
wherein the indication of the selected TCI state is received using one of a hybrid automatic repeat request (HARQ) acknowledgement (ACK) and an ACK transmission.

The computer program 1206 may arrive at the apparatus or network apparatus via any suitable delivery mechanism 1208. The delivery mechanism 1208 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 1206. The delivery mechanism may be a signal configured to reliably transfer the computer program 1206. The apparatus may propagate or transmit the computer program 1206 as a computer data signal.

The computer program 1206 can comprise computer program instructions for causing a UE 110 to perform at least the following or for performing at least the following:
receiving an indication of a plurality of candidate Transmission Configuration Indicator (TCI) states wherein the plurality of candidate TCI states comprise at least one TCI state different to the TCI state with which the UE is currently configured; and
transmitting an indication of a selected TCI state from the plurality of candidate TCI states where the selected TCI state is different to the TCI state with which the UE is currently configured; and
wherein the transmission of the selected TCI state uses one of a hybrid automatic repeat request (HARQ) acknowledgement (ACK) and an ACK transmission.

The computer program 1206 can comprise computer program instructions for causing an access node 120 to perform at least the following or for performing at least the following:
configuring a User Equipment (UE) with a first Transmission Configuration Indicator (TCI) state;
transmitting an indication of a plurality of candidate TCI states to the UE; and
receiving from the UE an indication of a selected TCI state from the plurality of candidate TCI states where the selected TCI state is different to the first TCI state;
wherein the indication of the selected TCI state is received using one of a hybrid automatic repeat request (HARQ) acknowledgement (ACK) and an ACK transmission.

The computer program instructions may be comprised in a computer program, a non-transitory computer readable medium, a computer program product, a machine readable medium. In some but not necessarily all examples, the computer program instructions may be distributed over more than one computer program.

Although the memory 1204 is illustrated as a single component/circuitry it may be implemented as one or more separate components/circuitry some or all of which may be integrated/removable and/or may provide permanent/semi-permanent/dynamic/cached storage.

Although the processor 1202 is illustrated as a single component/circuitry it may be implemented as one or more separate components/circuitry some or all of which may be integrated/removable. The processor 1202 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory (ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in FIGS. 5 to 6 can represent steps in a method and/or sections of code in the computer program 1206. The illustration of a particular order to the blocks does not necessarily imply that there is a required or preferred order for the blocks and the order and arrangement of the block may be varied. Furthermore, it can be possible for some blocks to be omitted.

Where a structural feature has been described, it may be replaced by means for performing one or more of the functions of the structural feature whether that function or those functions are explicitly or implicitly described.

In some but not necessarily all examples, the UE 110, and the network 100 are configured to communicate data with or without local storage of the data in a memory 704 at the UE 110, or the access nodes 120 and with or without local processing of the data by circuitry or processors at the UE 110, or the access nodes 120.

The data may be stored in processed or unprocessed format remotely at one or more devices. The data may be stored in the Cloud.

The data may be processed remotely at one or more devices. The data may be partially processed locally and partially processed remotely at one or more devices.

The data may be communicated to the remote devices wirelessly via short range radio communications such as Wi-Fi or Bluetooth, for example, or over long range cellular radio links. The apparatus may comprise a communications interface such as, for example, a radio transceiver for communication of data.

The UE 110 and/or the network 100 can be part of the Internet of Things forming part of a larger, distributed network.

The processing of the data, whether local or remote, can be for the purpose of health monitoring, data aggregation, patient monitoring, vital signs monitoring or other purposes.

The processing of the data, whether local or remote, may involve artificial intelligence or machine learning algorithms. The data may, for example, be used as learning input to train a machine learning network or may be used as a query input to a machine learning network, which provides a response. The machine learning network may for example use linear regression, logistic regression, vector support machines or an acyclic machine learning network such as a single or multi hidden layer neural network.

The processing of the data, whether local or remote, may produce an output. The output may be communicated to the UE 110, and the access nodes 120 where it may produce an output sensible to the subject such as an audio output, visual output or haptic output.

The above-described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1.-20. (canceled)

21. A User Equipment (UE) comprising:
at least one processor; and
at least one memory including computer program code,
the at least one memory and the computer program code configured to, with the at least one processor, cause the UE at least to perform:
receiving an indication of a plurality of candidate Transmission Configuration Indicator (TCI) states wherein the plurality of candidate TCI states comprise at least one TCI state different to the TCI state with which the UE is currently configured; and
transmitting an indication of a selected TCI state from the plurality of candidate TCI states where the selected TCI state is different to the TCI state with which the UE is currently configured; and
wherein the transmission of the selected TCI state uses one of a hybrid automatic repeat request (HARQ) acknowledgement (ACK) and an ACK transmission.

22. The UE as claimed in claim 21, wherein the at least one processor and the at least one memory are configured to cause the UE to perform switching the UE to the selected TCI state.

23. The UE as claimed in claim 21, wherein the at least one processor and the at least one memory are configured to cause the UE to assume Uplink transmissions using the selected TCI state starting at a predetermined time following the indication of the selected TCI state.

24. The UE as claimed in claim 21, wherein the HARQ-ACK is transmitted using the current TCI state.

25. The UE as claimed in claim 21, wherein the ACK is transmitted using the selected TCI state.

26. The UE as claimed in claim 21, wherein the at least one processor and the at least one memory are configured to cause the UE to perform selecting a TCI state from the candidate TCI states based on estimated Uplink budgets on the candidate TCI states.

27. The UE as claimed in claim 21, wherein the at least one processor and the at least one memory are configured to cause the UE to perform selecting a TCI state from the candidate TCI states based on whether a corresponding Reference Signal Received Power (RSRP) is above a threshold level.

28. The UE as claimed in claim 21, wherein the selected TCI state uses a different panel of the UE compared to the current TCI state.

29. The UE as claimed in claim 21, wherein a plurality of TCI states are associated into a group such that an indication of one of the TCI states in the group as a candidate TCI state enables the UE to consider other TCI states in the group as candidate states.

30. The UE as claimed in claim 21, wherein a reported number of HARQ-ACK bits is equal to a number of candidate TCI states.

31. The UE as claimed in claim 21, wherein the indication of a plurality of candidate TCI states is received from one or more node apparatus.

32. A method comprising:
receiving an indication of a plurality of candidate Transmission Configuration Indicator (TCI) states wherein the plurality of candidate TCI states comprise at least one TCI state different to the TCI state with which the UE is currently configured; and
transmitting an indication of a selected TCI state from the plurality of candidate TCI states where the selected TCI state is different to the TCI state with which the UE is currently configured; and
wherein the transmission of the selected TCI state uses one of a hybrid automatic repeat request (HARQ) acknowledgement (ACK) and an ACK transmission.

33. The method of claim 32, further comprising causing the UE to perform switching the UE to the selected TCI state.

34. The method of claim 32, further comprising causing the UE to assume Uplink transmissions using the selected TCI state starting at a predetermined time following the indication of the selected TCI state.

35. The method of claim 32 further comprising transmitting the HARQ-ACK using the current TCI state.

36. A node apparatus comprising:
at least one processor; and
at least one memory including computer program code,
the at least one memory and the computer program code configured to, with the at least one processor, cause the node apparatus at least to perform:
configuring a User Equipment (UE) with a first Transmission Configuration Indicator (TCI) state;
transmitting an indication of a plurality of candidate TCI states to the UE; and
receiving from the UE an indication of a selected TCI state from the plurality of candidate TCI states where the selected TCI state is different to the first TCI state;
wherein the indication of the selected TCI state is received using one of a hybrid automatic repeat request (HARQ) acknowledgement (ACK) and an ACK transmission.

37. The node apparatus of claim 36, wherein the at least one processor and the at least one memory are configured to cause the node apparatus to perform configuring the UE with the selected TCI state.

38. The node apparatus of claim 36, wherein the HARQ-ACK is received using the first TCI state.

39. The node apparatus of claim 36, wherein the ACK is received using the selected TCI state.

40. The node apparatus of claim 36, wherein a plurality of TCI states are associated into a group such that an indication of one of the TCI states in the group as a candidate TCI state enables the UE to consider other TCI states in the group as candidate states.
